(19) United States
(12) Patent Application Publication
(10) Pub. No.: US 2007/0054010 A1
(43) Pub. Date: Mar. 8, 2007

(54) High temperature enzymatic vegetable processing

(75) Inventors: Lisbeth Kalum, Vaerloese (DK); Niels Erik Krebs Lange, Soeborg (DK)

Correspondence Address: NOVOZYMES NORTH AMERICA, INC., 500 FIFTH AVENUE, SUITE 1600, NEW YORK, NY, 10110, US

(73) Assignee: NOVOZYMES A/S, BAGSVAERD (DK)

(21) Appl. No.: 10/575,702

(22) PCT Filed: Aug. 11, 2004
(86) PCT No.: PCT/DK04/00533

§ 371 Date: Apr. 13, 2006

(30) Foreign Application Priority Data
Aug. 13, 2003 (DK) PA 2003 01159

(51) Int. Cl. A23L 2/02

(52) U.S. Cl. 426/51

(57) ABSTRACT

This invention relates to a method of producing a vegetable product, comprising the steps of: a) crushing, chopping or slicing a vegetable into pieces of 1 to 30 mm; b) before of after step a) blanching the vegetable pieces at a temperature of 60° C. to 90° C.; c) holding the blanched vegetable pieces in the presence of an endo-acting pectinase activity at a temperature from 60° C. to 90° C.; and d) optionally blending the macerated vegetable pieces.

### FIELD OF INVENTION

This invention relates to a method of producing a vegetable product.

### BACKGROUND OF THE INVENTION

Enzymatic disintegration of plant material has been used in the production of vegetable purees, juices, or nectars. Controlled degradation of plant cell wall material can result in liberated single cell suspensions with good consistency, high retention and conservation of vitamins, colours, aroma etc. However, as enzyme preparations applied today possess relatively low thermostability the processes are performed at low temperatures allowing growth of microbial contaminants. In order to minimize the risk of microbial infections during the long incubation times of the conventional processes, typically ranging from 45 minutes to several hours, the pH is often adjusted from near neutral down to about pH 4.5. A process for low temperature enzymatic disintegration of plant material is provided in Danish patent application PA 2003 00462.

It is the object of the present invention to provide a process which can be conducted at a relative high temperature thereby reducing the risk of microbial infections associated with the conventional low temperature processes.

### SUMMARY OF THE INVENTION

It is an object of the present invention to provide improved methods of producing vegetable products.

Accordingly, the invention provides a process for producing a vegetable product, comprising the steps of: a) crushing, chopping or slicing a vegetable into pieces of 1 to 30 mm; b) before or after step a) blanching the vegetable pieces at a temperature of 60 to 90° C.; c) holding the blanched vegetable pieces in the presence of an endo-acting pectinase activity at a temperature from 60 to 90° C.; and d) optionally blending the macerated vegetable pieces.

With the process of the present invention the mechanical treatments can be reduced to a minimum. As the high temperature reduces microbial growth the need for strong acidification is reduced. This enable performing the process at a pH within a much broader range so that a pH suitable for the enzyme applied or for the intended end product may be chosen. The process of the invention allows close to 100% yield as the rather large yield losses normally experienced in the separation step are eliminated due to the effective high temperature enzymatic maceration step. The milling operation can be optimized securing less energy consumption and less damage to the cells. The high temperatures further induce maximal swelling of the vegetables thus increasing the accessibility of the enzymes. Pasteurization can also be performed in the enzymation tank or in a heat exchanger directly connected with the tank. Further it minimizes damages to the cells resulting in a very smooth consistency of the resulting suspension, high viscosity, better storage stability, improved organoleptic/sensoric properties, and, when used in juice production, in increased cloud stability. The high viscosity is very important when the vegetable product, e.g. a puree, is applied as baby food or as an ingredient in juices, soups or sauces, as it enhances mouth feel and reduces the need for additional thickening agent. Furthermore, as the cells are intact valuable constituents are protected from oxidation thereby increasing the nutritional value of the final product.

### DETAILED DISCLOSURE OF THE INVENTION

In the context of this invention a vegetable product is a liquid composition comprising vegetable dry substances. The dry substances may be present as a suspension of vegetable solids comprising fully homogenized vegetable material, intact single cells, clusters of several cells, or a mixture of these. The vegetable product of the invention may be used in any kind of food stuff, e.g. in baby foods, fruit juices, ketchups, soups or sauces.

The vegetable product of the invention may be produced from one vegetable or from a number of different vegetables selected from the list comprising root vegetables such as carrots celeries, beetroots, radishes, horse-radishes; fruit vegetables such as apples, pears, grapes, tomatoes, citrus (orange, lemon, lime, mandarin), mango, prunes, cherries, peas, beans, tomatoes, paprikas, cucumbers, and pumpkins; leaf and flower vegetables such as pineapple, spinach, cabbage, and cauliflower. According to this invention especially a vegetable product, such as a puree, from carrot, Daucus carota var. sativa, is preferred. Any suitable cultivar or type of carrot may be used including but not limited to Parisian market, Oxheart, Amsterdam forcing, Chantenay, Nantes, Danvers, Imperator, Flakkee, Berlikum, and Kuroda. For further types of carrots or other vegetable suitable for the present invention, please refer to World Vegetables. Principles, Production, and Nutritive values. 2^{nd} Edition. V. E. Rubatzky and M. Yamaguchi (Eds.), 1997, pp 418-456, Chapman & Hall.

If considered appropriate the vegetable may subjected to a pre-treatment e.g. but not limited to; washing, cleaning, destoning, and/or sorting before being subjected to the process of the invention.

In process step a) of the invention the vegetable is crushed in a mill, or chopped or sliced with knives into pieces of 1 to 30 mm, or preferably of 3 to 28 mm, or more preferably of 5 to 25 mm, such as of 10 to 20 mm,.One important effect of the process step (a) is to increase the surfaces area and thus allowing better access for the enzymes.

In process step b), which may be performed before and/or after process step a) the vegetable material is subjected to blanching. The term “blanching” means a short lasting thermal treatment wherein the vegetable material is subjected to the action of hot water or steam. One important effect of the thermal treatment is to stop unwanted enzymatic action, another to weakening the tissues and thus allowing better access for the enzymes. The blanching step (b) may have a duration of from 10 sec to 15 minutes, preferably from 30 sec to 10 minutes, more preferably from 1 to 8 minutes, and most preferably from 2 to 6 minutes. The blanching step (b) may be performed at a temperature within the range of 45-120° C., preferably within the range of 50-110° C., more preferably within the range of 60-100° C., and even more preferably within the range of 70-90° C.

Steps a) and b) may be performed in any order; so that the blanching step b) may be performed after or before the vegetable has been mechanically disintegrated into vegetable pieces.

Suitable endo-acting pectinase enzyme compositions for use in step c) of the invention comprise pectin depolymerases, such as polygalacturonase (EC 3.2.1.15), pectin lyase (EC 4.2.2.10) and pectate lyase (EC 4.2.2.2). The endo-acting pectinase weaken the intercellular cementing material of plant tissue called the middle lamella. The main component of the middle lamella is insoluble protopectin, which, however, becomes soluble after restricted degradation. The weakening of the middle lamella allows the separation of the vegetable tissue into individual single cells and/or clusters of loosely cohering single cells during or after the enzymatic treatment in process step c).

The enzyme composition applied in the present invention comprises an endo-acting pectnase activity selected from the list consisting of pectate lyase (EC 4.2.2.2), polygalacturonase (EC 3.2.1.15), pectin lyase (EC 4.2.2.10), pectin methylesterase (3.1.1.11) and pectin acetyl esterase. The enzyme compositions may be multi component enzyme compositions, or a mono component enzyme. The enzyme composition may comprise several different endo-acting pectinase activities. The enzyme composition preferably comprises a mono component endo-acting pectinase activity. The endo-acting pectinase may be a pectate lyase derived from Bacillus sp. such as the pectate lyase derived from Bacillus licheniformis (BI1) disclosed as SEQ ID NO:8 in WO 9927083 and shown herein as SEQ ID NO:1 herein or it may be a genetically modified pectate lyase, preferably a variant of a pectate lyase derived from a strain of Bacillus subtilis, and more preferably a variant of the amino acid sequence SEQ ID NO:2 herein (and disclosed as SEQ ID NO:2 in Danish patent application PA 2002 00746), or even more preferred, a variant having at least 50% homology, such as at least 60%, at least 70%, at least 80%, at least 90%, at least 95% or even at least 99% homology to the amino acid sequence disclosed in SEQ ID NO:2 herein or SEQ ID NO:2 in Danish patent application PA 2002 00746, and most preferably the variant is Bs1 having the alterations D48P +M64F +T105P +K1391+Q146H+K213T+K218P+T2581+A305P+S331P+S337R or Bs2 having the alterations D48P+M64F+T105P+K1391+Q146H+K213T+K218P+T2581+A305P+S331P+S337K.

The term “homology” is understood as the degree of identity between two sequences indicating a derivation of the first sequence from the second. The homology may suitably be determined by means of computer programs known in the art such as GAP provided in the GCG program package (Program Manual for the Wisconsin Package, Version 8, August 1994, Genetics Computer Group, 575 Science Drive, Madison, Wis., USA 53711) (Needleman, S. B. and Wunsch, C. D., (1970), Journal of Molecular Biology, 48, 443-453. The following settings for amino acid sequence comparison are used: GAP creation penalty of 3.0 and GAP extension penalty of 0.1.

Also preferred is an enzyme composition having pectin lyase activity derived from Aspergillus, preferably A. niger, A. aculeatus, or A. oryzae.

Endo-acting pectinases are used in effective amounts, preferably within the range of 0.05 to 5000 g enzyme protein/ton vegetable, more preferably within the range of 0.5 to 500 g enzyme protein/ton vegetable, even more preferably within the range of 1-250 g enzyme protein/ton vegetable and most preferably within the range of 5-100 g enzyme protein/ton vegetables.

The enzyme compositon may comprise one or more additional thermo stable enzymes selected from the list consisting of alpha-amylase, arabinofuranosidase, cellulase, glucanase and xylanase.

Preferably the duration of step (c) is within the range of 2 minutes to 24 hours, such as within the range of 5 minutes to 5 hours, such as within the range of 15 minutes to 4 hours, such as within the range of 30 minutes to 2 hours. Preferably the temperature is within the range of 60 and 90° C., preferably within the range of 64 and 87° C., more preferably within the range of 67 and 85° C., such as within the range of 70 and 83° C.

According to the invention the process is conducted at a pH within the range of from 4.0 to 8.0, or even within 5.0 to 7.8. In a preferred embodiment the pH is within the range of 6.0-7.5. If appropriate the pH may be adjusted to a desired value within any of the proceeding ranges using a suitable buffer, preferably citric acid or ascorbic acid.

Following the enzymatic treatment the vegetable material may be subjected to blending. The term “blending” means a gentle homogenization, just strong enough to disrupt the enzymatically weakened vegetable tissue to produce a suspension of individual single cells and/or clusters of loosely cohering single cells without disrupting the individual cells. The blending step (d) which is optional may be performed using a blender with rotating knives at a speed of 100-50000 rpm, or more preferably of 1000-10000 rpm. The blending may be performed for a period of 10 sec to 10 hours, preferably from 15 sec to 5 hours, more preferably from 20 sec to 1 hour, even more preferably from 25 sec to 30 minutes, such as from 30 sec to 5 minutes.

Following the enzyme treatment in step (c) or the optional blending step (d) remaining enzyme activity is preferably inactivated, e.g. by heating the mixture to a temperature of 80-121° C., or preferably 85-95° C., the precise temperature and the incubation time chosen according to the thermal stability of the specific enzyme composition used. The inactivation may be performed in conjunction with a pasteurization step.

The invention is further illustrated in the following example, which is not intended to be in any way limiting to the scope of the invention as claimed.

### EXAMPLES

Materials and Methods

The enzyme preparations used were the pectate lyase BI1 from Bacillus licheniformis and two genetically modified pectate lyases from Bacillus subtilis; Bs1 having the alterations D48P+M64F+T105P+K1391+Q146H+K213T+K218P+T2581+A305P+S331P+S337R or the Bs2 having the alterations D48P+M64F+T105P+K1391+Q146H+K213T+K218P+T2581+A305P+S331P+S337K.

Dry substance (DS) was determined after 24 hours incubation at 105° C.

Determination of cloud stability of diluted puree was made by mixing 5 ml puree with 5 ml de-ionized water. The amount of formed sediment was measured after 24 hours incubation at 5° C. A high amount of sediment after storage corresponds to juice with good cloud stability.

The release and molecular weight distribution of the soluble polysaccharides, oligosaccharides and monosaccharides was followed using high performance size exclusion chromatography. The samples were filtered u sing through a 0.46 micromillimeter filter and separated on four Guardcolumn TSK-gel PWXL Toso Haas; G2500; G3000; G4000; G5000 connected in a row (0.4 M acetic acid adjusted to pH 3.0 using sodium acetate as eluent). Detection of eluted saccharides was performed using a refractive index detector RID6A (Shimadzu Japan). The molecular weight of selected fractions was estimated based on logarithm values of molecular weights of known Dextran standards.

Viscosity was determined by placing 50 ml puree in a Rapid Visco Analyser RVA-4 (Newport Scientific, Australia) at 25° C. using a shear of 200 rpm. The viscosity was recorded over 2 minutes and the mean result was calculated in centiPoise (cP).

Free color of carrot purees was determined as heptane extractable carotenoides. 1 mL juice was pipetted into a centrifuge vial. 2 mL heptane was added and the free carotenoides were extracted by turning and mixing with caution. The heptane phase (top) was transferred to a new vial. Extraction was preformed twice and the heptane phases were pooled. Carotenoide content was measured by spectrophotometric scan at 476 nm with heptane as reference.

Total color of carrot purees was determined as propanol extractable carotenoides. 1 mL juice was weighed into a centrifuge vial. 12 mL propan-2-l was added and the vial was mixed and left for sedimentation over night. The sample was centrifuged for 2 minutes at 3000 rpm and the supernatant was transferred to a new vial. The extraction procedure was repeated with 5 ml until the cells were colorless. Supernatants were pooled and centrifuged for 5 minutes at 4000 rpm. Spectrophotometric measurement was performed at 476 nm with propan-2-ol as reference.

The number of undamaged vegetable cells compared to the total number of released cells was estimated from the ratio between free color of carotenoides and total color.

### Example 1

Carrots were purchased from the local market. The dry substance of the carrots was 9.25%. 1.5 kg of the carrots was peeled by hand and milled using a Bucher Mill, KFG 112 M6-P (O. Bartholdi AG, CH) equipped with 3 mm blades. The milled carrots were blanched in 6 l of de-ionized water for 3 minutes at 80° C. The water was drained and the carrot pieces drip dried for about 10 minutes. 100 ml 50 mM Tris buffer pH 7.5 containing 1 mM CaCl₂ was added to 100 g of blanched carrots (dry substance 4.68%). The temperature was equilibrated in a water bath at 70° C. Enzyme or water was added and gently stirred. The dose of the enzyme preparations were 7.5 g purified enzyme protein/ton of blanched carrots. The mixture was incubated for 2 hours at 70° C. without further stirring.

The enzymes were inactivated by heating the mixture to 80° C. and holding the temperature for 10 minutes.

The formed carrot puree was filtered through a 0.5 mm screen. The dry weight of particles larger than 0.5 mm (residual) was determined by drying at 105° C. until constant weight. The puree yield was calculated using the formula: (%DS_{blanched carrot}Dry weight_{residual})/(% DS_{blanched carrot})*100.

| | | | Sediment of | | |
|---|---|---|---|---|---|
| | | | puree | | Average weight |
| | Yield | Viscosity | dilutions | Free colour | of main |
| Enzyme | (%) | (cP) | (ml) | (%) | fractions (kDa) |
| Control | 39.8 | 82 | 0.5 | 11.0 | 900, 55 |
| BL1 | 69.2 | 87 | 2.0 | 11.7 | 750, 34 |
| BS1 | 73.5 | 88 | 2.0 | 11.2 | 650, 160, 5.5 |
| BS2 | 72.8 | 87 | 2.0 | 10.8 | 700, 160, 6.7 |

A significant increase in yield was obtained by addition of pectate lyase compared to control. The cloud stability of the enzyme treated pulp was increased compared to control. The viscosity of the enzyme treated pulps was comparable to the control. The increase in yield was obtained without any further cell disruption. The level of degradation of the soluble carbohydrates were more pronounced using the enzymes BS1 and BS2 compared to BL1.

1-7. (canceled)

8. A process for producing a vegetable or fruit product, comprising the steps of:
a) crushing, chopping or slicing a vegetable or fruit into pieces of 1 to 30 mm; before or after step
a) blanching the vegetable or fruit pieces at a temperature of 60 to 90° C.; and
b) holding the blanched vegetable or fruit pieces in the presence of an endo-acting pectinase activity at a temperature from 60 to 90° C.

9. The process of claim 8, further comprising optionally blending the blanched vegetable or fruit pieces.

10. The process of claim 8, wherein the endo-acting pectinase activity is selected from the list comprising pectate lyase, polygalacturonase, pectin lyase, pectin methyl esterase and pectin acetyl esterase.

11. The process of claim 8, wherein the pectate lyase is derived from a strain of Bacillus sp.

12. The process of claim 8, wherein the pectate lyase is derived from a strain of of B. licheniformis.

13. The process of claim 8, wherein the pectate lyase is derived from a strain of B. subtilis.

14. The process of claim 8, wherein the pectate lyase has the amino acid sequence SEQ ID NO:1.

15. The process of claim 8, wherein the pectate lyase has the amino acid sequence SEQ ID NO:2.

16. The process of claim 8, wherein the vegetable is a root vegetable.

17. The process of claim 8, wherein the vegetable is a carrot, celery, beetroot, radish, or horseradish.

18. The process of claim 8, wherein the fruit is an apple, pear, mango, grape, tomato, citrus, prune, or cherry.


SEQUENCE LISTING (2 sequences)

SEQ ID NO: 1 - protein, 341 aa, Bacillus licheniformis
MKKLISIIFIFVLGVVGSLTAAVSAEAASALNSGKVNPLADFSLKGFAALNGGTTGGEGGQTVTVTTGDQLIAALKNKNANTPLKIYVNGTITTSNTSASKIDVKDVSNVSIVGSGTKGELKGIGIKIWRANNIIIRNLKIHEVASGDKDAIGIEGPSKNIWVDHNELYHSLNVDKDYYDGLFDVKRDAEYITFSWNYVHDGWKSMLMGSSDSDNYNRTITFHHNWFENLNSRVPSFRFGEGHIYNNYFNKIIDSGINSRMGARIRIENNLFENAKDPIVSWYSSSPGYWHVSNNKFVNSRGSMPTTSTTTYNPPYSYSLDNVDNVKSIVKQNAGVGKINP

SEQ ID NO: 2 - protein, 399 aa, Bacillus subtilis [sequence omitted]